(19) United States
(12) Patent Application Publication
(10) Pub. No.: US 2014/0216418 A1
(43) Pub. Date: Aug. 7, 2014

(54) FUEL PUMP AND FUEL SUPPLY SYSTEM OF INTERNAL COMBUSTION ENGINE

(71) Applicant: Kazuhiro Asayama, Nagoya-shi (JP)

(72) Inventor: Kazuhiro Asayama, Nagoya-shi (JP)

(73) Assignee: TOYOTA JIDOSHA KABUSHIKI KAISHA, Toyota-shi (JP)

(21) Appl. No.: 14/342,957

(22) PCT Filed: Sep. 6, 2011
(86) PCT No.: PCT/JP2011/004982

§ 371 Date: Mar. 5, 2014

(51) Int. Cl. F02M 69/02

(52) U.S. Cl. CPC F02M 69/02
USPC 123/495

(57) ABSTRACT

In order to provide a fuel pump capable of effectively suppressing a generation of fuel vapor by reducing heat which is transferred from the pump body to the fuel therein, the fuel pump includes a pump body in which a fuel introduction passage and a fuel pressurizing chamber are formed, and a pressurizing pump mechanism having an outer end lubricated by oil and operative to pressurize and discharge the fuel in the pressurizing chamber by a power inputted to the outer end. The pump body includes a fuel accommodation portion formed with at least part of the fuel introduction passage, and a barrier wall portion for regulating the oil from being introduced into the fuel accommodation portion. The fuel accommodation portion and the barrier wall portion are connected with each other through a heat transmission path which is provided therein with a heat transmission member having a higher heat transfer performance than that of a material forming the pump body, the heat transmission member includes a connecting part exposed to the outside of the pump body.

### TECHNICAL FIELD

The present invention relates to a fuel pump and a fuel supply system of an internal combustion engine, more particularly, to a fuel pump adapted to pressurize fuel to a high pressure enough to directly inject the fuel into cylinders of the engine, and a fuel supply system for internal combustion engine applying the fuel pump.

### BACKGROUND ART

There has been recently known an internal combustion engine for a vehicle in which fuel is directly injected into a cylinder, or fuel is injected not only into a cylinder but also into an intake port.

In such an internal combustion engine, a fuel supply system for pressurizing fuel supplied from a feed pump to a higher pressure by a pressurizing fuel pump is employed. This is because it is necessary to pressurize fuel to a higher pressure and feed the fuel to a fuel injection valve (injector) for injecting into a cylinder.

As this kind of a fuel pump for supplying a pressurized fuel and a fuel supply system, there has been generally used a pump with a plunger slidably arranged in a pump body (a pump housing) and reciprocally moved by a pump cam driven by a rotary power supplied from the internal combustion engine.

To be more precise, there is known a fuel pump mounted on the side wall of the cylinder head through a pump mounting case and driven by a pump cam which is provided integrally with a portion of an exhaust cam shaft, the portion being extended from the side wall of the cylinder head toward the outer side (see, for example, Patent Document 1,). This fuel pump is configured so that reciprocally moving parts of the pump is not only cooled with a coolant circulating path bypassing a thermostat, formed by communicating a water-jacket of the engine to a coolant passage in the pump mounting case, at a high load operating condition or the like, but also heated at a cool operating condition.

There is also known a marine engine with a fuel pump surrounded by a water jacket to which a coolant is supplied from a water jacket of the engine (see, for example, Patent Document 2).

### CITATION LIST

### Patent Literature

{PTL1} Japanese Patent Application Publication No. 2008-202441
{PTL2} Japanese Patent Application Publication No. H06-280709

### SUMMARY OF INVENTION

### Technical Problem

However, the above-mentioned conventional fuel pump is mounted on a cylinder head or the like, and the top end of the plunger or the tappet thereof is driven by the pump driving cam of the engine. As a result, in the pump body of the fuel pump, the metal parts exposed to the inside of the cylinder head, and the metal parts positioned in the vicinity of the top end of the plunger or the tappet, are easily heated by the pump driving cam or the cylinder head immersed in the engine oil in the operating state of the engine, and are apt to be heated to a high temperature.

Accordingly, it is difficult effectively to cool the pump body even when the reciprocal parts is cooled by a coolant supplied from the water jacket of the engine and introduced into a cooling path of the fuel pump, because a heat conducted from the engine through the pump driving cam is more significant. Therefore, there is likely to generate fuel vapor at an inner path framed in a metal part easily heated by the engine or in an inner bottom portion of the fuel storing chamber.

Moreover, the cooling in the fuel pump is stopped under a high temperature heat soak state in which ambient temperature around the fuel pump temporarily reaches high temperature because a water circulation in the water jacket and a cooling by a radiator are halted when the engine stops. As a result, the fuel in the fuel pump becomes high temperature and thus there is likely to generate fuel vapor in an inner path formed in a metal part easily heated by the engine or in an inner bottom portion of the fuel storing chamber.

Accordingly, a fuel supply system of an internal combustion engine using the above conventional fuel pump as a fuel pressurizing pump may deteriorates a fuel supply performance and a starting performance of the engine due to sucking of the fuel vapor into the fuel pressurizing pump.

It is therefore an object of the present invention to provide a fuel pump capable of effectively suppressing a generation of fuel vapor by reducing heat which is transferred from the pump body to the fuel therein, and alao to provide a fuel supply system for an internal combustion engine with a higher fuel supply performance by using the fuel pump.

### Solution to Problem

In order to solve the above problem, a fuel pump according to the present invention comprises (1): a pump body in which a fuel introduction passage for introducing fuel from an outside and a pump operation chamber for introducing the fuel through the fuel introduction passage are formed; and a pressurizing pump mechanism having an input part lubricated by oil from the outside and operative to pressurize and discharge the fuel in the pump operation chamber by a power inputted to the input part, wherein the pump body includes a fuel accommodation portion formed with at least part of the fuel introduction passage, and a barrier wall portion for regulating the oil from being introduced into the fuel accommodation portion, and wherein the fuel accommodation portion and the barrier wall portion are connected with each other through a heat transmission path which is provided therein with a heat transmission member having a higher heat transfer performance than that of a material forming the pump body, the heat transmission member includes a connecting part exposed to the outside of the pump body.

The fuel pump according to the present invention transferees a heat received by the barrier wall portion of the pump body to a direction apart from the fuel accommodation portion with the heat transmission member having the connecting part exposed to the outside of the pump body, and inhibit the heat transferring to the fuel accommodation portion. Therefore, the heat received by the pump body of the fuel pump is hard to be transferred to the fuel in the fuel pump, and thus a generation of fuel vapor can be effectively suppressed. Note, the outside of the pump body in this description means at least the outside of the fuel accommodation portion, and the heat receiving part of the heat transmission member means a part enable to transfer a heat to the outside of the fuel accommodation portion.

The fuel pump according to the present invention is preferably configured so that (2) the pump body is mounted on an outer wall portion of an internal combustion engine, and the input part inputs a power from a driving member mounted on the internal combustion engine, and wherein the heat transmission member has an end portion projected from the pump body, the end portion being connected to a low temperature portion forming part of the internal combustion engine and lower in temperature than the remaining portion thereof.

By this configuration, the barrier wall portion of the pump body is easily heated by a heat conducted from the outer wall of the engine, a heat generated at the input part when driven by the driving member, and a heat conducted from the lubricating and cooling oil in the engine which becomes a very high temperature compared with the fuel temperature. On the other hand, the heat is hard to be conducted to the fuel accommodation portion because the heat is transferred from the fuel accommodation portion through the heat transmission member to the low temperature portion of the engine.

The fuel pump according to the present invention is preferably configured so that (3) the heat transmission member includes a high heat conduction member having a high heat conductivity than that of the material forming the pump body, and a heat insulating sheath member covering part of the high heat conduction member protruded from the pump body.

In this case, a cheap and reliable member such as a copper wire covered with heat-insulated material can be applied for a part or main part of the heat transmission member.

The fuel pump with the above defined configuration (3) is preferably configured so that (4) the high heat conduction member is formed in a band-like shape or a string-like shape.

By this configuration, it is possible to easily set the heat transmission path from the pump body to the low temperature portion of the engine. Additionally, the heat transmission member may be comprised of a laminated body in which high heat conduction materials of a band-like or string-like shape are laminated in multiple layers, or of a bundle of heat conduction materials.

The fuel pump according to the present invention is preferably configured so that (5) the heat transmission member includes a heat pipe.

By this configuration, the heat received at the barrier wall portion of the pump body is effectively transferred through the heat pipe in a direction away from the fuel accommodation portion, and thus the heat is hard to be conducted to the fuel accommodation portion. Note, the heat pipe is not limited to a rod-like shape, and may be a belt-like shape or may be combined integrally with a high heat conduction material.

The fuel pump according to the present invention is preferably configured so that (6) the pressurizing pump mechanism is constituted by a pump operative to reciprocate a plunger, and the input part is provided at an outer end portion of the plunger, and wherein the barrier wall portion of the pump body is arranged, in a direction in which the plunger is reciprocated, between the pump operation chamber of the fuel introduction passage in the pump body and the outer end portion of the plunger of the pressurizing pump mechanism.

By this configuration, the heat received at the barrier wall portion of the pump body is effectively transferred through the heat transmission member in a direction away from the fuel accommodation portion, and thus the heat is hard to be conducted to the fuel introduction passage and the pump operation chamber. Additionally, a heat generated by a friction between the plunger and the pump body can also be transferred through the heat transmission member in a direction away from the fuel accommodation portion.

A fuel supply system of an internal combustion engine according to the present invention is (7) a system provided with the fuel pump defined in any one of the above configurations. The fuel supply system includes a feed pump operative to pump up fuel from a fuel tank and to feed the fuel to the fuel introduction passage; and a delivery pipe for storing fuel pressurized and discharged by the pressurizing pump mechanism and supplying the fuel to a fuel injection valve, wherein the fuel accommodation portion of the pump body has a fuel storing chamber formed therein, the fuel storing chamber forming part of the fuel introduction passage and storing the fuel from the feed pump, and wherein the heat transmission member is extended to a vicinity of the fuel storing chamber in the fuel accommodation portion.

According to the fuel supply system of this invention, a heat conducted to the pump body of the fuel pump is hard to be conducted to the fuel in the fuel pump, and thus a generation of fuel vapor in the fuel pump is effectively suppressed. As a result, it is possible to remove a drawback in that a sufficient discharge pressure of fuel is not obtained due to pressurizing of the fuel including vapor, and thus to improve the fuel supply performance.

The heat transmission member referred to in the present invention may be provided to extend to parts of the pump body other than the barrier wall portion. For example, the heat transmission member may extend to a high temperature portion other than the barrier wall portion, or to a heat transmission path between the barrier wall portion and the high temperature portion. It is desirable that the inner end side portion of the heat transmission member positioned in a heat transmission path between the fuel accommodation portion and the barrier wall portion extends to a portion where the fuel accommodation portion is closest to the barrier wall portion. Moreover, it is desirable that the barrier wall portion holds a seal member to seal a sliding gap between the plunger and the plunger holder, and the barrier wall portion may hold the plunger holder slidably holding the plunger.

The heat transmission path between the fuel accommodation portion and the barrier wall portion preferably means a heat conduction path made of metal arranged between the fuel accommodation portion and the barrier wall portion. The path between the fuel accommodation portion and the barrier wall portion includes a fixing surface of the pump body, and it is possible that the heat transmission member includes an inner end portion interposed between the fixing surface of the pump body and the surface for fixing the pump. It is also of course that the heat transmission member may be provided with both a high heat conduction member with a heat-insulated sheath and a heat pipe.

### Advantageous Effects of Invention

According to the present invention, heat received at the barrier wall portion of the pump body is transferred through the heat transmission member to the outside of the pump body, and thus is hard to be transferred to the fuel accommodation portion. Therefore, it is possible to provide a fuel pump in which the heat conducted to the pump body is hard to be transferred to the fuel in the fuel pump and which can effectively suppress a generation of fuel vapor in the fuel pump. Moreover, it is possible to provide a fuel supply system for an internal combustion engine with a higher fuel supply performance by using the fuel pump.

### BRIEF DESCRIPTION OF DRAWINGS

FIG. 1 is a cross section view showing a schematic configuration of a fuel pump according to a first embodiment of the present invention.

FIG. 2 is an oblique perspective view of the appearance of an internal combustion engine with the fuel pump according to the first embodiment of the present invention.

FIG. 3 is a schematic configuration diagram of a fuel supply system of an internal combustion engine with the fuel pump according to the first embodiment of the present invention.

FIG. 4 is an enlarged cross sectional view showing a main part in a pressurizing pump mechanism of the fuel pump according to the first embodiment of the present invention.

FIG. 5 is a cross section viewed from the direction indicated by arrows V-V in FIG. 1.

FIG. 6 is an enlarged cross sectional view showing a main part in an input part in the pressurizing pump mechanism of the fuel pump according to the first embodiment of the present invention.

FIG. 7 is a cross-sectional view of an oil seal holder showing a shape in plan of a heat transmission member in the fuel pump according to the first embodiment of the present invention.

FIG. 8 is a timing chart for explaining the action of the fuel supply system of the internal combustion engine according to the first embodiment of the present invention.

FIG. 9 is a cross-sectional view of an oil seal holder showing a shape in plan of a heat transmission member in the fuel pump according to the second embodiment of the present invention.

FIG. 10 is an enlarged cross-sectional view showing a main part in an input part in the pressurizing pump mechanism of the fuel pump according to the second embodiment of the present invention.

### DESCRIPTION OF EMBODIMENTS

The preferable embodiments of the present invention will be described hereinafter with reference to the accompanying drawings.

### First Embodiment

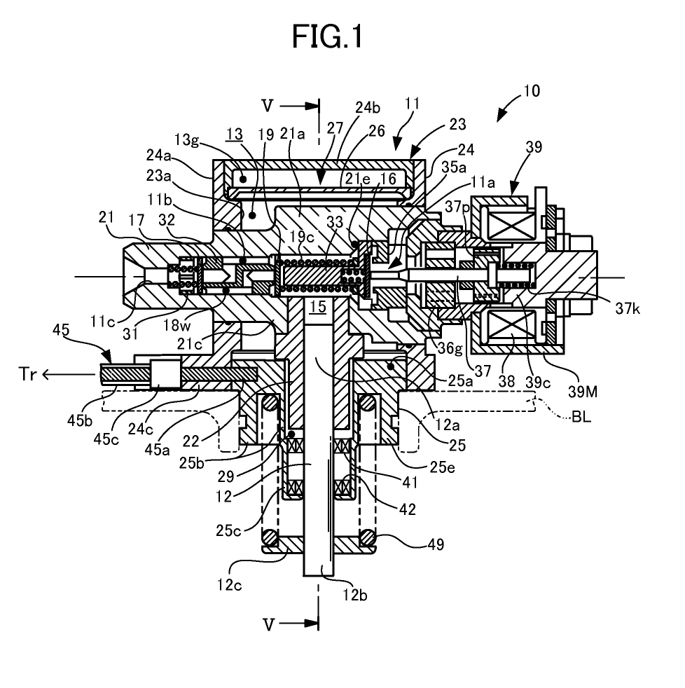

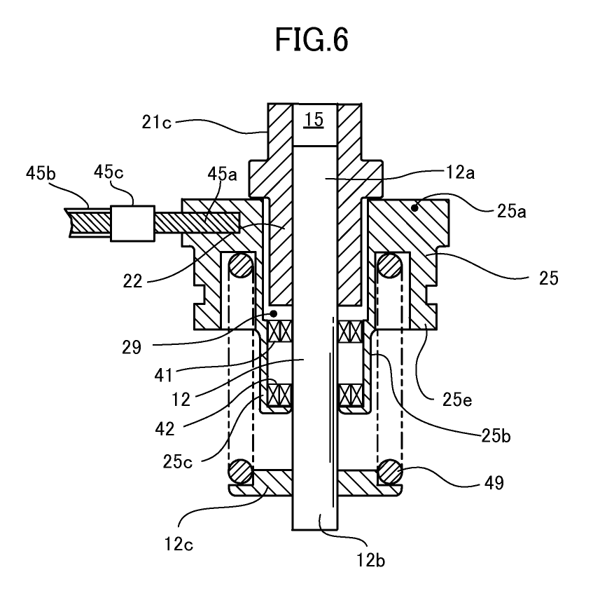

FIGS. 1 to 8 show a fuel supply system which is provided with a fuel pump according to the first embodiment of the present invention.

As shown in FIGS. 1 to 3, the fuel pump according to the present embodiment is exemplified as a fuel pump 10 which is of a plunger pump type for use in pressurizing the fuel at a high pressure. The fuel pump 10 is provided as part of a fuel supply system on an engine E such as for example a duel injection type of a V-type multi-cylinder gasoline engine (internal combustion engine, hereinafter simply referred to as “engine”) mounted on an automotive vehicle.

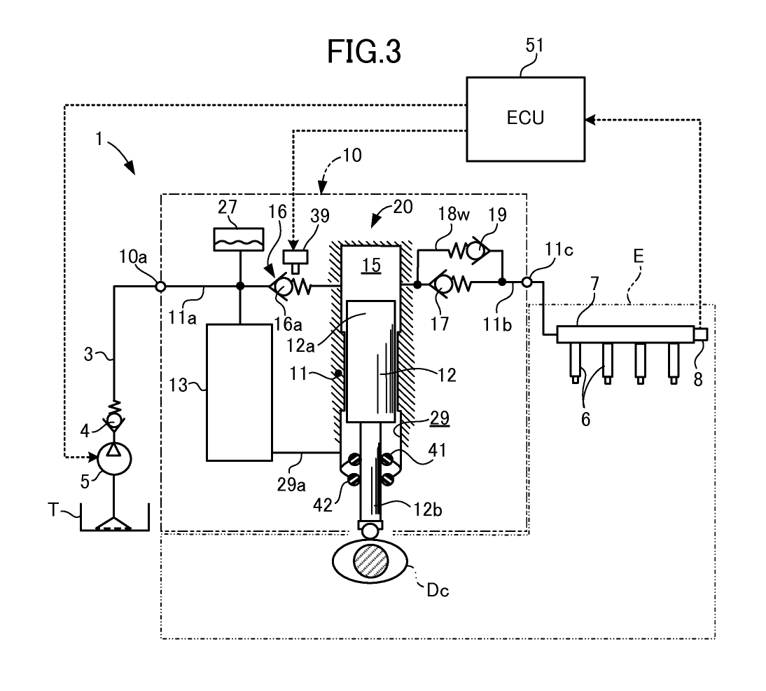

As shown in FIG. 3 with the schematic construction of the fuel supply system, the fuel supply system 1 comprises a delivery pipe 7 for distributing fuel at a high pressure to a plurality of injectors (fuel injection valves) for use in injecting the fuel into cylinders, respectively. The delivery pipe 7 is constructed to be supplied by a fuel pump 10 with the high pressure fuel to be pressurized and stored therein.

The fuel pump 10 is connected through a pipe 3 and a check valve 4 with a feed pump 5 provided in a fuel tank T. From the feed pump 5 to the fuel pump 10 is introduced the fuel pressurized to a relatively low feed pressure. Here, the fuel pump 5 is constituted for example by an electrically operated low pressure fuel pump capable of pumping up gasoline, one of the fuels, reserved in the fuel tank T. The fuel discharged from the fuel pump 5 is adapted to be fed to the injectors not shown, and to have the fuel pressure adjusted by a pressure regulator also not shown.

As shown in FIGS. 1 to 6, the fuel pump 10 has a pump body 11 and a plunger 12, the pump body 11 being mounted on the outer wall portion BL (including a pump attaching case integrally mounted on the outer wall portion), while the plunger 12 being provided on the pump body 11 to be axially reciprocatable with respect to the pump body 11. In the pump body 11, a suction passage 11a (fuel introduction passage) for introducing therein the fuel from the feed pump 5 and a discharge passage 11b for discharging the fuel pressurized in the pump body 11 to the delivery pipe 7 are formed. The delivery pipe 7 is adapted to store the high pressure fuel pressurized in and discharged from the fuel pump 10 and to maintain the pressure of the fuel at a high pressure, so that the delivery pipe 7 can distribute and feed the high pressure fuel to each of the injectors 6 which is opened. Each of the injectors 6 is provided in each of the cylinders of the engine E, not shown in detail, to inject the fuel into the cylinder.

The part of the suction passage 11a of the pump body 11 constitutes a suction gallery chamber 13 (fuel storing chamber) positioned at the upstream side of the suction valve 16 and capable of storing the fuel from the feed pump 5. The suction gallery chamber 13 is held in communication with an auxiliary chamber 29 through a communication passage 29a. The auxiliary chamber 29 is formed between the outer end portion 12b (one lower end in FIG. 1) of the plunger 12 and the pump body 11. The communication passage 29a allows the fuel to move between the suction gallery chamber 13 and the auxiliary chamber 29 in response to the reciprocal displacement of the plunger 12. The pump body 11 has a fuel introduction pipe portion, not shown, projecting outwardly of the pump body 11 and having a forward end portion formed with a suction opening 10a (see FIG. 3). In the vicinity of the suction opening portion 10a is provided a fuel filter not shown.

The plunger 12 has an inner end portion 12a (one upper end portion of the pump operation chamber, FIG. 1) slidably received in the pump body 11. In the pump body 11, between the plunger 12 and pump body 11 is formed a fuel pressurizing chamber 15 which is held in communication with the suction passage 11a and the discharge passage lib. The fuel pressurizing chamber 15 has a volume varied, viz., increased or decreased, to enable the fuel to be sucked therein or discharged therefrom in response to the reciprocal displacement of the plunger 12.

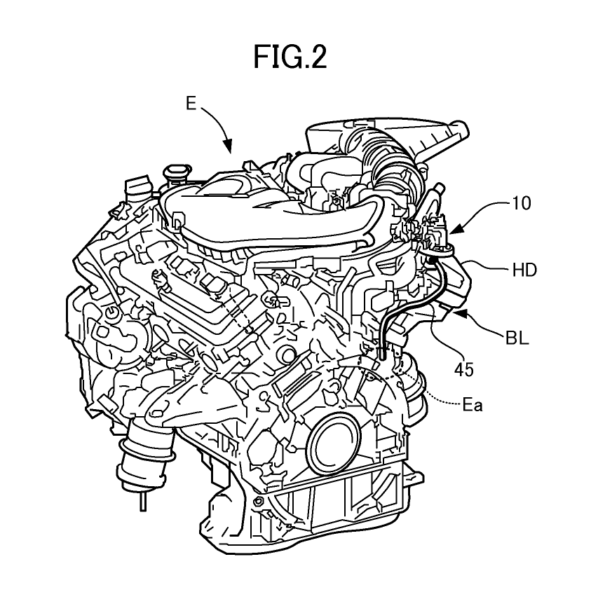

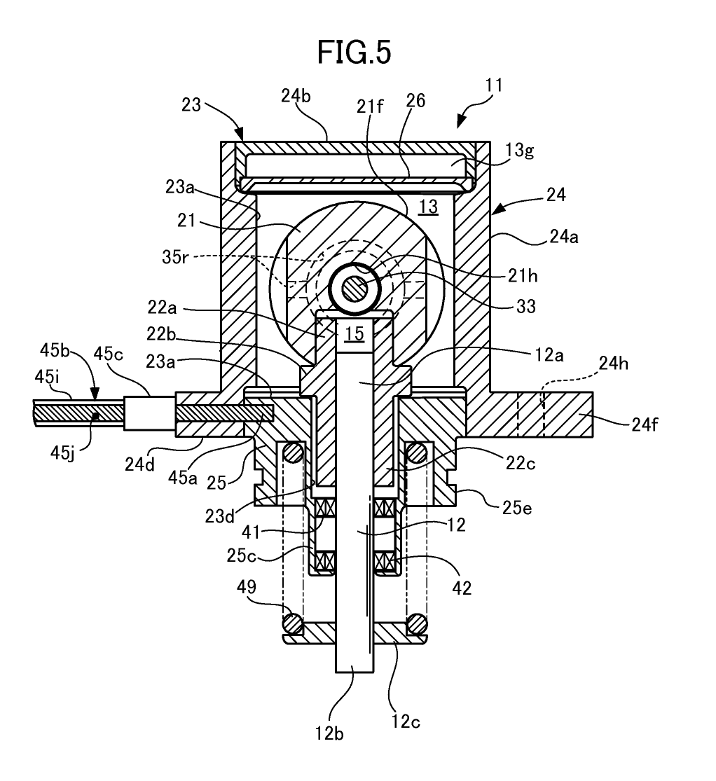

As shown in FIGS. 2 and 3, the plunger 12 is held at its outer end portion 12b in engagement with a driving cam (driving member) Dc through a roller, a tappet and the like. The driving cam Dc is provided in the cylinder head I-ID (not shown in detail) of the engine E to drive the plunger 12. In the neighborhood of the outer end portion 12b of the plunger 12 is provided a spring seat 12c (see FIG. 5). Between the spring seat 12c and the pump body 11 is assembled a compression coil spring 49 which is maintained in the compressed state. This means that the plunger 12 is always resiliently urged by the compression coil spring 49 in a direction (downwardly in FIG. 1) to increase the volume of the fuel pressurizing chamber 15. The plunger 12 is therefore adapted to be driven to reciprocate in response to the rotation of the driving cam Dc when the driving cam Dc is driven to rotate by the driving force of the engine E.

The fuel pump according to the present embodiment comprises a suction valve 16 and a discharge valve 17 which are disposed at the upstream and downstream sides of the fuel pressurizing chamber 15, viz., at the suction and discharge sides of the fuel pressurizing chamber 15, respectively. The suction valve 16 allows the fuel to be introduced into the fuel pressurizing chamber 15 at the downstream side of suction gallery chamber 13 and is constructed by a check valve which can fulfill a backflow prevention function. The discharge valve 17 allows the fuel to be discharged from the fuel pressurizing chamber 15 and is constructed by a check valve which can fulfill a backflow prevention function. The suction valve 16 and the discharge valve 17 are defined as parts of plural valve elements.

In response to the upward displacement in FIG. 1 of the plunger 12 to decrease the volume of the fuel pressurizing chamber 15, the pressure of the fuel in the fuel pressurizing chamber 15 is increased, so that the discharge valve 17 is opened under the closed state of the suction valve 16. On the other hand, in response to the downward displacement in FIG. 1 of the plunger 12 to increase the volume of the fuel pressurizing chamber 15, the pressure of the fuel in the fuel pressurizing chamber 15 is decreased, so that the suction valve 16 is opened under the closed state of the discharge valve 17.

At the discharge side of the fuel pressurizing chamber 15 in the pump body 11, a bypass passage 18w bypassing the discharge valve 17 is formed and a relief valve 19 capable of opening and closing the bypass passage 18w is installed. The relief valve 19 is defined as one of the plural valve elements.

The relief valve 19 is constructed to be opened when the pressure of the fuel in the discharge passage 11b downstream of the discharge valve 17 is higher than the pressure of the fuel in the fuel pressurizing chamber 15 by a predetermined pressure level to open the relief valve, more specifically, when the pressure of the fuel in the fuel pressurizing chamber 15 reaches a predetermined pressure equivalent to the pressure at which the fuel is introduced into the fuel pressurizing chamber 15 in the state that the pressure of the fuel at the delivery pipe 7 reaches a predetermined pressure level.

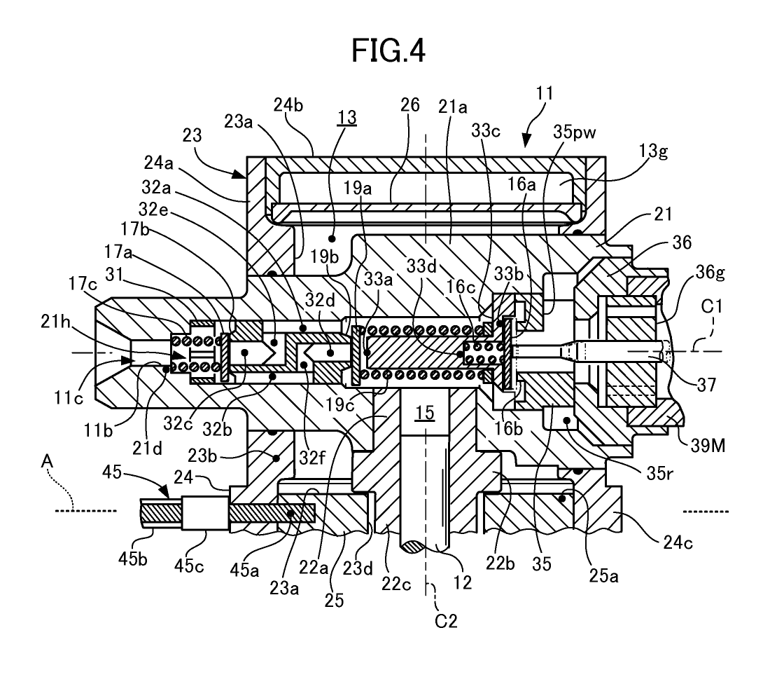

As shown in FIG. 4, the suction valve 16 is constituted by a plate-like valve element 16a, an annular valve seat 16b operative together to open and close the suction passage 11a and a preload coil spring 16c (resilient member) for retaining a closed state in which the valve element 16a is held in engagement with the valve seat 16b until the pressure of the fuel in the suction passage 11a reaches a predetermined suction pressure (lower than the feed pressure by the predetermined suction valve opening difference pressure). Similarly, the discharge valve 17 is constituted by a plate-like valve element 17a, an annular valve seat 17b operative together to open and close the discharge passage 11b and a preload coil spring 17c (resilient member) for retaining a closed state in which the valve element 17a is held in engagement with the valve seat 17b until the pressure of the fuel in the discharge passage 11b reaches a predetermined discharge pressure (higher than the pressure of the fuel in the delivery pipe by the predetermined discharge valve opening difference pressure). Further, the relief valve 19 is constituted by a plate-like valve element 19a, an annular valve seat 19b operative together to open and close the bypass passage 18w (see FIGS. 1 and 3), and a preload coil spring 19c (resilient member) for retaining a closed state in which the valve element 19a is held in engagement with the valve seat 19b until the pressure of the fuel in the discharge passage 11b is raised or the pressure of the fuel in the fuel pressurizing chamber 15 is decreased to have the pressure difference upstream and downstream of the valve element 19a reach a predetermined relief valve opening difference pressure. In addition, the plate-like valve elements 17a, 19a are each roughly in a disc shape and have respective outer peripheral portions fainted with notches each serving as a passage for allowing the fuel to pass there through.

The previously mentioned pump body 11, the plunger 12, the fuel pressurizing chamber 15, the suction valve 16, the discharge valve 17 and the driving cam DC constitutes as a whole a pressurizing pump mechanism 20.

It is therefore understood that the pressurizing pump mechanism 20 has the fuel pressurizing chamber 15 formed to serve as a pump operation chamber between the suction passage 11a and the discharge chamber 11b in the pump body 11 to enable the fuel to be pressurized in the fuel pressurizing chamber 15 and discharged from the fuel pressurizing chamber 15 by the operation of the plunger 12. The outer end portion 12b of the plunger 12 is lubricated by engine oil (oil from the outside) at the cylinder head HD side of the engine E, and constitutes an input portion driven by the driving cam Dc. The driving cam Dc is for example integrally mounted on the one end portion of an exhaust cam shaft (not shown in detail) of the engine E. The installation form of the driving cam Dc itself is the same as that disclosed for example by the Patent Document 1.

As shown in FIGS. 4 and 5, the pump body 11 is constructed to have a cylindrical valve retaining member 21, a cylinder member 22 serving as a plunder holder portion for retaining the plunger 12 to be slidable in the axial direction of the plunger 12, and an outer shell member 23 having an inner surface 23a held in face-to-face relationship with at least part of the valve retaining member 21 and the cylinder member 22. The valve retaining member 21, the cylinder member 22, and the outer shell member 23 have respective vertical cross-sectional shapes formed to have respective symmetrical shapes roughly in axis-symmetrical relationship with one another with respect to the center axis of the valve body 11. The valve retaining member 21, the cylinder member 22, and the outer shell member 23 respectively have a pure or quasi symmetrical shape.

The valve retaining member 21 and the cylinder member 22 are partly inserted in the outer shell member 23 in such a manner that the axes of the valve retaining member 21 and the cylinder member 22 are in perpendicular relationship with each other, and the retaining member 21 and the cylinder member 22 partly penetrate the inner wall surface 23a of the outer shell member 23a. The outer shell member 23, the inserted portion 21a of the valve retaining member 21 inserted into an inner space formed roughly in a cylindrical shape, and a flange portion 22b forming part of the cylinder member 22 collectively form the suction gallery chamber 13 serving as a fuel storing chamber. The inserted portion 22a of the cylinder member 22 is connected with the inserted portion 21a of the valve retaining member 21 within the outer shell member 23, thereby forming the fuel pressurizing chamber 15 with the inserted portion 21a of the valve retaining member 21 and the inserted portion 22a of the cylinder member 22.

The valve retaining member 21 is formed in a cylindrical shape and has a valve accommodating bore 21h and an outer peripheral surface 21f. The valve accommodating bore 21h axially extends in the central portion of the valve retaining member 21, and is circular in cross-section and in a stepped form having increased diameters step by step toward the right end side in FIGS. 1 and 4. The outer peripheral surface 21f is in a stepped form. The valve retaining member 21 accommodates therein the suction valve 16, the discharge valve 17 and the relief valve 19 being together defined as the plural valve elements in the valve accommodating bore 21h to be held in a series arrangement state, viz., in axial alignment with one another.

The valve retaining member 21 has a left end portion in FIG. 4 formed with a downstream end exit 11c forming part of the discharge passage 11b, the downstream end exit 11e being positioned at the most downstream side of the valve accommodating bore 21h. As shown in FIGS. 1 and 4, the valve accommodating bore 21h of the valve retaining member 21 accommodates therein the first to third valve stoppers 31, 32, 33, the discharge valve 17, the relief valve 19 and the suction valve 16.

The first valve stopper 31 is constituted by an annular member having slits and snugly fitted with the smallest diameter portion of the valve accommodating bore 21h of the valve retaining member 21 to regulate the maximum displacement in the opening direction of the valve element 17a of the discharge valve 17. The second stopper 32 is constituted by a passage forming member having two cranked passages forming part of the discharge passage 11b and the bypass passage 18w. More specifically, the second valve stopper 32 is formed with a pair of annular bores 32a, 32b, a pair of axial bores 32c, 32d and a pair of radial bores 32e, 32f. The annular bores 32a, 32b axially extend around the outer peripheral surface of the second valve stopper 32. The axial bores 32c, 32d axially extend to be open at the axially outer ends of the second valve stopper 32, and to have a predetermined depth. The radial bores 32e, 32f have the annular bores 32a, 32b held in communication with the axial bores 32c, 32d.

The second valve stopper 32 has one end portion formed with a valve seat 17b forming part of the discharge valve 17 and axially and annularly extending, and the other end portion formed with a valve seat 19b forming part of the relief valve 19 and axially and annularly extending. The valve element 17a of the discharge valve 17 and the valve element 19a of the relief valve 19 are respectively in face-to-face relationship with the valve seats 19b, 19b at the both axial ends of the second valve stopper 32. The preload coil spring 17c is disposed between the step portion 21d of the valve retaining member 21 at the most downward position of the valve accommodating bore 21h and preloaded with the predetermined force corresponding to the pressure to open the discharge valve 17.

The third valve stopper 33 is constituted by a member having a cross-section formed roughly in a T-shape and having stopper portions 33a, 33b held in face-to-face relationship with the relief valve 19 and the suction valve 16 and spring seats 33c, 33d taking radially outward and inward positions, respectively, and extending in axially opposite directions, the stopper portions 33a, 33b and the spring seats 33c, 33d being integrally formed with one another. Therefore, the third valve stopper 33 has a function to regulate the axially movable ranges of the valve elements 16a, 19a and a function to receive the preload coil springs 16c and 19c. The preload coil spring 19c of the relief valve 19 is disposed between the valve element 19a of the relief valve 19 and the spring seat 33c of the third valve stopper 33, and preloaded with the predetermined force corresponding to the pressure to open the relief valve 19. On the other hand, the preload coil spring 16c of the suction valve 16 is disposed between the valve element 16a of the suction valve 16 and the spring seat 33d of the third valve stopper 33, and preloaded with the predetermined force corresponding to the pressure to open the suction valve 19.

The third valve stopper 33 is held in face-to-face relationship with a passage forming member 35 partly forming the annular spring seat 16b of the suction valve 16 at the outer peripheral portion of the spring seat 33c occupying the right side in FIG. 4. The outer peripheral portion of the spring seat 33c is partly cut to have the fuel pressurizing chamber 15 held in communication with the passage in the vicinity of the valve seat 16b of the suction valve 16. The passage forming member 35 is formed with a communication passage 35pw extending from the suction gallery chamber 13 to the fuel pressurizing chamber 15 in the valve retaining member 21 and forming part of the suction passage 11a. The valve seat 16b of the suction valve 165 at the one end portion of the passage forming member 35 partly surrounds the downstream end of the communication passage 35pw, and axially and annularly projects toward the fuel pressurizing chamber 15.

The passage forming member 35 is retained by a plug member 36 for operatively supporting an operating member 37 in the state that the passage forming member 35 is pushed toward the stepped portion 21e formed on the valve retaining member 21 together with the stopper portion 33b of the third valve stopper 33(see FIG. 1). The plug member 36 is for example screwed to the right end portion of the valve retaining member 21 in FIG. 4. The passage forming member 35, the plug member 36, and the stepped portion 21e of the valve retaining member 21 collectively form an annular communication passage 35r (see FIGS. 4, 5) partly held in communication with the suction gallery chamber 13 to serve as part of the communication passage 35pw. The above construction allows the communication passage 35pw to axially extend in the central portion of the valve retaining member 21 at its side near the valve seat 16b of the suction valve 16 to be open at the inside of the valve seat 16b, and at its side near the suction gallery chamber 13 to extend radially and axially of the passage forming passage 35 to be open at the outer peripheral surface 21f of the valve retaining member 21 in the suction gallery chamber 13.

The operating member 37 is slidably supported on a guide portion 36f forming part of the plug member 36, and operative to be subject to a pressing operation force in a direction to have the valve element 16a of the suction valve 16 (rightward in FIGS. 1, 4) to be opened, so that the suction valve 16 can be opened against the urging force of the preload coil spring 16c urging the valve element 16a in a direction to close the valve element 16a.

The operating member 37 forms part of an operating plunger received in an electromagnetic coil 38 at the right end side in FIG. 1, and can be attracted into the electromagnetic coil 38 when the electromagnetic coil 38 is energized and excited. This means that the valve element 16a of the suction valve 16 is returned by the urging force of the preload coil spring 16c in a direction to close the valve body 16a when the electromagnetic coil 38 is non-energized (“OFF” state). The operating member 37 and the electromagnetic coil 38 constitute as a whole an electromagnetic operation unit 39 which is adapted to control the time period to forcibly open the suction valve 16, thereby making it possible to variably control the period in which the fuel is pressurized in the fuel pressurizing chamber 15 by the plunger 12.

More concretely, the operating member 37 has a base end portion around which is provided a movable core 37p with a diameter nearly equal to the inner diameter of the electromagnetic coil 38. At a body 39M forming of the electromagnetic operation unit 39 accommodating the electromagnetic coil 38 is provided a stator core 39c in face-to-face relationship with the movable core 37p. Between the base end portion of the operating member 37 and the stator core 39c is provided a compression coil spring 37k (resilient member) in a compressed state to resiliently urge the operating member 37 in a direction to open the suction valve 16. The preload of the compression coil spring 37k is adapted to impart an urging force additionally acting in the same direction as that of the urging force to open the valve element 16a of the suction valve 16 based on the different pressure between the downstream side and the upstream side of the valve element 16a, so that the preload of the compression coil spring 37k is set to open the suction valve 16 against the force of the preload spring 16c in the direction to close the valve element 16a.

As shown in FIGS. 4 and 5, the cylinder member 22 of the pump body 11 is supported at its inner end side on the valve retaining member 21. The cylinder member 22 has an insertion portion 22a inserted into an axially intermediate portion 21c forming part of the cylindrical valve retaining member 21, a flange portion 22b adjacent to the inversion portion 22a and expanded in diameter, and a cylindrical portion 22c slidably receiving the forward end portion of the plunger 12.

The outer shell member 23 of the pump body 11 comprises a cup member 24 comprising a cylindrical part 24a with a roughly cylindrical shape and a cover 24b covering one end of the cylindrical part 24a and an oil seal holder 25 fit on the cup member 24 so that contacting with the cylinder member 22 and covering the open end of the cup member 24, and having a center hole.

The cup member 24 is integrally constituted with flange part 24h having a fixing surface 24d and fixing holes 24h. The oil seal holder 25 comprises oil seal holding parts 25c holding plural oil seals 41 and 42, and fitting bosses 25e concentrically arranged with the plunger 12 and having a roughly cylindrical shape. The oil seals 41 and 42 seal the auxiliary chamber 29 held in communication with the gap between the plunger 12 and the cylinder member 22 and are installed between the oil seal holder 25 and the plunger 12.

On the outer shell member 23, an elastic film member 26 receiving the pressure of the fuel stored in the suction gallery chamber 13 is arranged so as to come close to the cover 24b. The elastic film member 26 works as a so-called pulsation damper 27 to absorb pulsations of the pressure of the fluid in the suction passage 11a.

The cup member 24 of the outer shell member 23 and the upper surface 25a of oil seal holder 25 forming the suction gallery chamber 13 above dotted line A in FIG. 4 configure a fuel accommodation portion 23b.

On the other hand, the lower surface 25b of the oil seal holder 25 works as a regulation wall portion to prevent the high temperature oil scattering near the outer end portion 12b in the cylinder head of the engine E being introduced into the fuel accommodation portion 23b. The inside of the oil seal holder 25 works as a heat transmission path between the fuel s accommodation portion 23b and the lower surface 25b, viz., a heat transmission path from the lower surface 25b of the oil seal holder 25 to the fuel accommodation portion 23b. The oil seal holder 25 may be rigidly fixed with the cylinder member 22 slidably supporting the plunger 12 of the pump body 11, or may be arranged with a gap from the cylinder member 22.

Parts receiving a high pressure among the cylindrical valve retaining member 21 and the cylinder member constituting the pump body 11, and the cup member 24 and the oil seal holder 25 constituting outer shell member 23 are made of high stiffness metal material such as stainless steal or other steal (for example, carbon steel or special steal). Parts receiving a low pressure (viz. parts not receiving a high pressure) among the cylindrical valve retaining member 21 and the cylinder member constituting the pump body 11, and the cup member 24 and the oil seal holder 25 constituting outer shell member 23 are made of the materials applied for the parts receiving a high pressure or materials with lower stiffness. Machine works are applied for contact-surfaces with other parts, sliding-surfaces or fitting surfaces of the cylindrical valve retaining member 21 and the cylinder member constituting the pump body 11, and the cup member 24 and the oil seal holder 25 constituting outer shell member 23.

A heat conducting member 45 with heat conducting coefficient of the heat conducting direction Tr apart from the fuel accommodation portion 23b higher than that of steal materials making of the pump body 11 are arranged between the upper surface 25a of the oil seal holder 25 constituting the fuel accommodation portion 23b of the outer shell member 23 and the lower surface 25b of the oil seal holder for preventing high temperature oil from flowing into the fuel accommodation portion 23b of the outer shell member 23.

The heat conducting member 45 is comprised of a heart receiving part 45a inserted or embedded into the pump body 11, a heat conducting part 45b protruding from the pump body 11 so as to transfer the heat received by the heat receiving part 45a to an outside low temperature part such as a low temperature part of the engine E, and a connecting part 45c for transferring the heat from the heat receiving part 45a with high heat conductivity to the heat conducting part 45b.

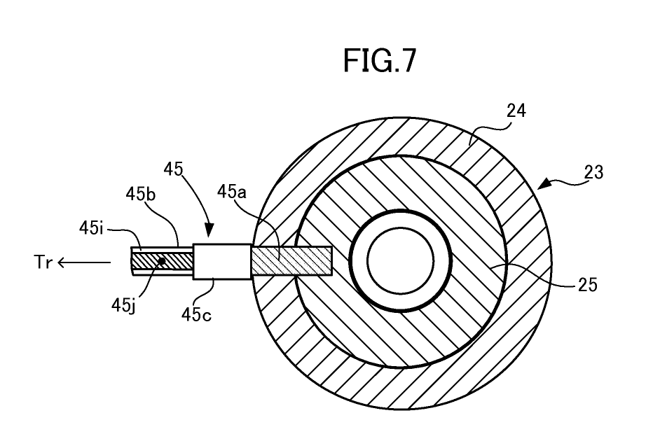

In concrete terms, the heat receiving part 45a is made from a heat pipe or is made of copper or aluminum having heat conductivity higher than steel. As shown in FIG. 7, the heat receiving part 45a is inserted into the outer shell member 23 of the pump body 11. Further, as shown in FIG. 1, the inside end of the heat receiving part 45a is positioned between the upper surface 25a and the lower surface 25b of the oil seal holder 25.

In the case that the heat receiving part 45a is made from the heat pipe, the heat receiving part 45a has a hydraulic fluid inside, and the inside end the heat receiving part 45a works as an evaporating part, the heat conducting part 45b protruding from the pump body 11 works as a condensing part, and the connecting part works as a wick part for transferring the hydraulic fluid by the capillary phenomena. The above mentioned constitution of the heat pipe is well-known. Note, the heat pipe is not limited by a rod type, and may be a plate type with a two-dimensional arrangement of the inside paths or an integral type integrated with high conductivity material.

The heat conducting part 45b is comprised of a copper wire 45j (high heat conductivity material) covered by heat insulating material 45i, or a member 45j with a rod shape or a belt shape having high conductivity extremely higher than that of the pump body 11 covered by heat insulating material. The heat conducting part 45b configures the end edge of the heat conducting member protruding from the pump body 11, and is connected to an external low temperature part, such as the low temperature part Ea of engine E (for example, an inlet of the coolant. The heat conducting part 45b may be connected to a low temperature part with large calorific capacity in vicinity of the engine E instead of the low temperature part Ea of engine E. The wire or member 45j may be a code or a belt made from a bundle of wires, or a lamination layer of high conductivity material.

The connecting member 45c connects the outer edge of the heat receiving 45a to one edge of the heat conducting member 45c with a large cross section, and for example is composed of a metal connecting member having high heat conductivity integrated with the heat receiving member 45a protruding from the pump body 11. The connecting member 45c is connected to the metal connecting member having high conductivity of the heat conducting member 45b with a bolt, welding or soldering, and works as a surface for transferring heat to an external member. The heat conducting member 45b is connected to the connecting member 45c, and is extended to the predetermined direction.

The above-mentioned electromagnetic operation unit 39 is excited ECU 51 shown in FIG. 3, when the lift amount of the plunger 12 periodically changes because the plunger 12 is driven by the driving cam Dc of the fuel pump 10 rotated by the engine E in operating condition. Namely, fuel amount necessary to compensate a fuel shortage in the delivery pipe or fuel pressure due to fuel injections is periodically calculated by ECU 51, the electromagnetic coil 38 is energized for a time period corresponding to the calculated fuel amount by ECU 51 during the lift amount of the plunger 12 increases.

When the electromagnetic coil 38 of the electromagnetic operating unit 39 is energized, the operating member 37 is attracted by the electromagnetic coil 38 against the force urged by the compression spring 37k to open the suction valve 16, and the suction valve open.

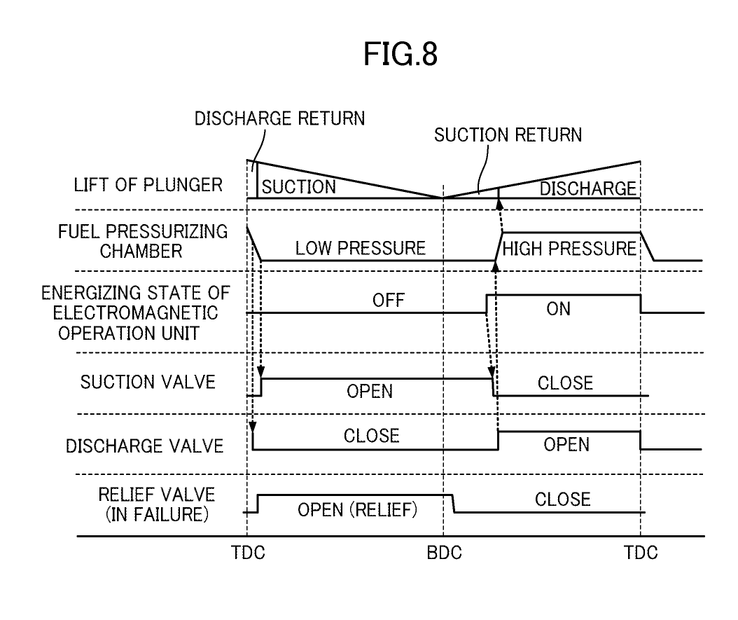

When the lift amount of the plunger 12 is decreased and the volume of the fuel pressurizing chamber 15 is increased, the discharge valve 17 connected to the delivery pipe fuel pressure therein is high keeps the valve closing state, but the suction valve 16 keeps the valve opening state because the electromagnetic operating unit 39 is not energized as shown in FIG. 8. Therefore, at this moment, fuel is suctioned to the fuel pressurizing chamber 15. On the other hand, when the lift amount of the plunger 12 is increased and the volume of the fuel pressurizing chamber 15 is decreased, the suction valve is closed at the moment the electromagnetic operating unit 39 is energized, and fuel in the fuel pressurizing chamber 15 is pressurized. Therefore, the pressure of fuel in the fuel pressurizing chamber 15 is increased, and the discharge valve 17 is opened. At this moment, the pressure of fuel discharged from the fuel pressurizing chamber 15 is, for example, about 4 to 20 M Pa.

Additionally, when the pressure of fuel at the downstream of the suction valve 17 is excessively increased due to some trouble (failure), the relief valve 19 is opened to prevent the delivery pressure from becoming excessively high at the moment the lift of the plunger 12 is decreased and the volume of the fuel pressurizing chamber 15 is increased. That is, the relief valve 19 is opened when the delivery pressure reaches at an abnormal level over the normal presser level. Note, in FIG. 8, TDC means the top dead center of the plunger 12 (maximum lift) and BDC means the bottom dead center of the plunger 12 (minimum lift).

Meanwhile, at the moment except the suction valve opening moment, ECU cuts the energy to the electromagnetic coil 38 (off state in FIG. 8), and the suction valve 16 is opened by the opening force argued by the compression spring 37k of the operating member 37 in the electromagnetic operating unit 39.

As shown in FIG. 8, the suction valve 16 is opened when the pressure of fuel in the fuel pressurizing chamber 15 is decreased, and the discharge valve 17 is opened before the timing that the suction valve is opened, viz., the pressure of fuel in the fuel pressurizing chamber 15 is being decreased. Then, during the suction valve 15 is open, fuel is suctioned into the fuel pressurizing chamber 15, because the lift of the plunger 12 is decreased and the volume of the fuel pressurizing chamber 15 is increased. While, when the lift amount of the plunger 12 is increased, and the volume of the fuel pressurizing chamber 15 is decreased in response to the rotation of the driving cam Dc, fuel in the fuel pressurizing chamber 15 discharges to the suction passage 11a and the pressure of fuel in the fuel pressurizing chamber 15 is not pressurized to the predetermined fuel pressure.

Hereafter, the action of this system will be explained.

The pump body 11 of the above-explained fuel pump 10 and fuel supply system 1 according to the present embodiment is mounted on the outer wall BL of the engine E, and the outer end 12b of the plunger 12 is moved by the driving cam Dc arranged on the engine E. Therefore, the lower surface 25b of the oil seal holder 25 in the pump body 11 easily reaches a high temperature, because the lower surface 25b is heated by heat conducted from the outer wall BL of the engine E, heat arising at the outer end 12b of the plunger 12 contacting with the driving cam Dc, and heat conducted from the lube oil inside the engine E which is higher in temperature than the temperature of fuel.

According to the present invention, the heat conducted to the oil seal holder 25, especially its lower surface 25b is transferred by the heat conducting member 45 to the direction Tr which directs to the outside of the pump body 11 apart from the fuel accommodation portion 23b, and seldom transferred to the fuel accommodation portion 23b. Therefore, fuel in the fuel pump is not easily heated by a heat conducted to the pump body 11 of the fuel pump 10, and a generation of fuel vapor in the fuel pump 10 is effectively inhibited.

Further, according to the present embodiment, as the heat conducting part 45b of the heat conducting member protruding from the pump body 11 is connected with the low temperature part Ea (See FIG. 2) of the engine E, heat conducted to the pump body 11 is easily transferred to the low temperature part Ea of the engine E. A heat is seldom conducted to the fuel accommodation portion 23b.

Further, as the heat conducting member 45 is comprised of the heat conducting part 45b which can be made from copper which is a cheap and reliable material, the heat conducting member 45 becomes economical and reliable. Moreover, as the heat conducting material 45j applied for the heat conducting part 45b has a rod shape or a belt shape, it becomes easier to mount the heat conducting member 45 from the pump body 11 to the low temperature part Ea of the engine E.

As the heat conducting member 45 has a heat receiving member 45a comprised of a heat pipe, heat absorbed in the oil seal holder 25 of the pump body 11, etc. is easily transferred to by the heat conducting member 45 to the direction Tr which directs to the outside of the pump body 11 apart from the fuel accommodation portion 23b.

Additionally, according to the present embodiment, the pressurizing pump mechanism 20 is comprised of a plunger pump with a plunger reciprocated by a force argued at the outer end of the plunger, and the lower surface 25b of the oil seal holder 25 is arranged between the suction path 11a of the pump body 11 and the fuel pressurizing chamber 15, and the outer end of the plunger 12 concerning to the reciprocating direction of the plunger 12. Therefore, heat absorbed in the oil seal holder 25 of the pump body 11, etc. is easily transferred to by the heat conducting member 45 to the direction Tr which directs to the outside of the pump body 11 apart from the fuel accommodation portion 23b.

According to the present embodiment, as a generation of fuel vapor in the fuel pump 10 is effectively inhibited due to less heat conducting to fuel in the suction gallery chamber 13, it becomes possible effectively to avoid occurring a condition where the fuel pump pressurizes fuel containing vapors and a pressure of the fuel is not enough pressurized. The fuel supply performance will be extremely improved.

As described above, heat received by the lower surface 25b of the oil seal holder 25 in the pump body 11 is easily transferred to the direction Tr apart from the fuel accommodation portion 23b by the heat conducting member 45 and is seldom transferred to the fuel accommodation portion 23b. Therefore, it is possible to provide the fuel pump 10 which can inhibit heat conducted to the pump body conducting to the fuel accommodation portion 23b, and a generation of vapors in the suction gallery chamber 13. Further, it is possible to provide the fuel supply mechanism 1 with an improved fuel supply performance by applying the above fuel pump 10.

The heat conducting path from the fuel accommodation portion to the regulation wall portion in the present description means the heat conducting path made of metal from the fuel accommodation portion to the regulation wall portion. This heat conducting path includes the fitting surface of the pump body.

### Second Embodiment

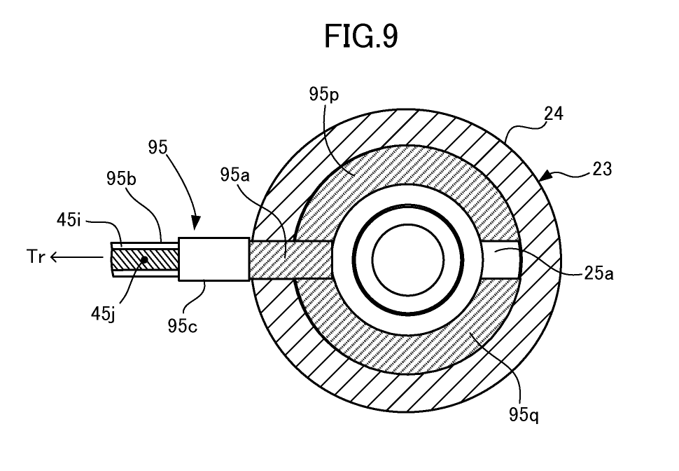

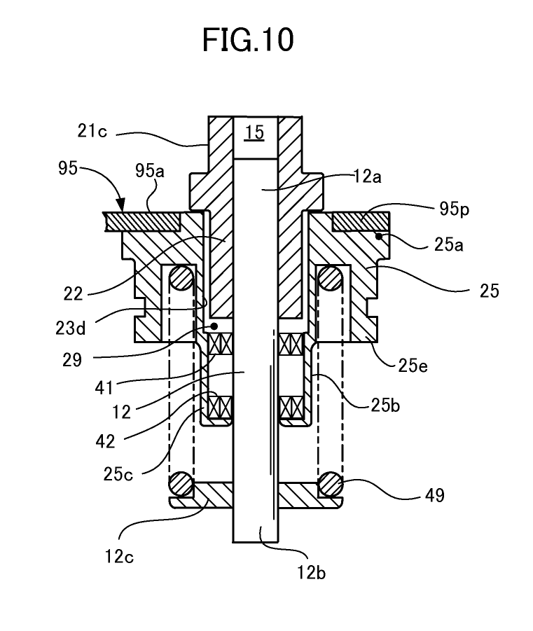

FIGS. 9 and 10 show the configuration of the pump body according to the second embodiment of the present invention. In this embodiment, the heat conducting member is mounted on the upper surface of the oil seal holder, and the other configuration is the same as the first embodiment. Therefore, points of difference from the first embodiment will be explained below using the same reference numerals to the elements same or similar as the first embodiment.

As shown in FIGS. 9 and 10, the heat conducting member 95 according to the present embodiment is comprised of a heart receiving part 95a inserted or embedded into the pump body 11, a heat conducting part 95b protruding from the pump body 11 so as to transfer the heat received by the heat receiving part 95a to an outside low temperature part Ea such as a low temperature part of the engine E, and a connecting part 95c for transferring the heat from the heat receiving part 95a with high heat conductivity to the heat conducting part 95b.

The heat receiving part 95a is comprised of a heat conducting material with heat conductivity higher than a steel applied for the pump body such as an aluminum or a copper. The heat receiving part 95a is inserted into the outer shell member 23, and mounted on the upper surface 25a of the oil seal holder 25 concerning the height direction as shown in FIGS. 9 and 10.

More precisely, the heat receiving part 95a of the heat receiving member 95 provides a pair of arc-like extended parts 95p and 95q as shown in FIG. 9, and the heat receiving part 95a supports the two parts 95p and 95q so that the two parts 95p and 95q surround the plunger 12.

The arc-like extended parts 95p and 95q may be previously installed in the outer shell member 23 after mounted on the upper surface 25a of the oil seal holder 25 and may be connected to the heat conducting part 95 a when the heat conducting part 95 a of the heat conducting member 95 is inserted into the outer shell member 23. While, the arc-like extended parts 95p and 95q may be previously connected to the heat conducting part 95.

The heat conducting part 95b and the connecting part 95c is constructed nearly the same as the heat conducting part 45b and the connecting part 45c of the above-mentioned first embodiment. That is, the connecting part 95c is used for connecting the heat receiving part 95a to the heat conducting part 95c with a cross area larger than other part, and works as a metal connecting part having high conductivity integrated with the heat receiving part 95a. The heat conducting part 95b is a part for fixing the metal connecting part having high conductivity integrated with the heat receiving part 95a, and works as a connecting surface for transferring a heat outside the pump body 11. Additionally, the heat conducting part 95b is connected to the connecting part 95c and extended to a predetermined direction for transferring heat.

In the present embodiment, a heat received at the lower surface 25b of the oil seal holder 25 is transferred to a direction Tr apart from the fuel accommodation portion part 23b, inhibited to be transferred to the fuel accommodation portion 23b. Therefore, fuel in the fuel accommodation portion 23b is seldom heated, and the fuel pump 10 able to inhibit a generation of vapors in the fuel pump 10 is provided. Further, it is possible to provide the fuel supply mechanism 1 with an improved fuel supply performance by applying the above fuel pump 10.

The heat receiving part 45a of the heat receiving member 45 of the first embodiment is inserted into the oil seal holder 25 and the heat receiving part 95a of the heat receiving member 95 of the second embodiment is mounted on the upper surface, but the heat receiving part of the heat receiving member may be clipped between the pump body and a setting surface of the engine for the pump body. Moreover, the heat conducting member of the present invention may be arranged the whole part of the pump body except the regulation wall portion. That is, the heat conducting member may cover high temperature part of the pump body except the regulation wall portion which is easily heated to a high temperature, or heat conducting path between the high temperature part and the regulation wall portion.

Further, the heat conducting path from the fuel accommodation portion 23b to the lower surface 25b of the oil seal holder 25 of the above embodiments may include the setting surface for the pump body, and the heat conducting member may be clipped between the setting surface for the pump body and the pump body.

Additionally, the heat receiving part 45a of the heat conducting member 45 arranged between the fuel accommodation portion 23b and the lower surface side portion 25b of the oil seal holder 25 is preferably extended to a potion where the fuel accommodation portion 23b mostly approaches the oil seal holder 25, but the direction in which the heat receiving part 45a is inserted into the outer shell member 23 is not limited to the radial direction of the outer shell member 23. The heat receiving part 45a may intersect with the radial direction in a predetermined angle so that an inserted length becomes longer. The connecting part 45c or 95c has a connecting surface outside the pump body 11 for conducting heat. The connecting surface may be an outer end surface of the connecting part 45c or 95c protruded from the pump body 11 or be an inner surface of a concave portion on the outer surface of the pump body 11. Further, the connecting part 45c or 95c may be directly connected to the low temperature part of the engine E without applying the heat conducting part 45b or 95b of a rod or belt shape. In this case, the connecting part 45c or 95c may become an end part of the heat conducting member 45.

The heat conducting member may be constituted not only by a high conductivity heat conducting part and a heat pipe, but also by either one of a high conductivity heat conducting part and a heat pipe. The oil seal holder 25 may hold the cylinder member 22 slidably holding the plunger 12. Further, the cylindrical valve retaining member 21 of the above-mentioned embodiments is inserted in the outer shell member 23, but it is not essential for configuring the suction gallery chamber 13.

As explained above, the fuel pump according to the present invention is configured so that heat received by the regulation wall portion of the pump body is transferred outside the pump body by the heat transferring member, is seldom transferred to the fuel accommodation portion. Therefore, a heat transferred to the pump body is seldom transferred to a fuel in the fuel accommodation portion, and the fuel pump capable effectively to inhibit a generation of vapor is provided. Further, the fuel supply system with high performance of supplying a pressurized fuel is provided by applying the present fuel pump. Therefore, the present invention is useful for a fuel pump capable pressurizing a fuel to a high pressure enough to directly inject the fuel in cylinders of an engine, and a fuel supply system for internal combustion engine applying the fuel pump.

### REFERENCE SIGNS LIST

1 Fuel supply system
5 Feed pump (Low pressure fuel pump)
6 Injector (Fuel injection valve)
7 Delivery pipe
10 Fuel pump
11 Pump body
11a Suction passage (Fuel introduction passage)
12 Plunger (Pressurizing member)
12b Outer end (Input part)
13 Suction gallery chamber (Part of fuel introduction passage, Fuel accommodation portion)
15 Fuel pressurizing chamber (Pump operation chamber)
16 Suction valve
17 Discharge valve
18w Bypass passage
19 Relief valve
20 Pressurizing pump mechanism
21 Valve holding member
22 Cylinder member (Plunger holding member)
23 Outer shell member
23b Fuel accommodation portion
24d Fixing surface
24f Flange part
25 Oil seal holder (Heat conduction passage)
25a Upper surface side portion
25b Lower surface side portion (Barrier wall portion)
39 Electromagnetic operation unit
41, 42 Oil seal
45, 95 Heat transmission member
45a, 95a Hear receiving part (one end part, inside end part)
45b, 95b Heat transmission part (protruded part, outside end)
45c, 95c Connecting part
45i Heat insulating sheath member
45j Copper wire (High heat conduction member, Material)
95p, 95q Extended part
BL Outer wall portion
Dc Driving cam (Driving member)
E Engine (Internal Combustion Engine)
Ea Low temperature portion (Part in low temperature)

1. A fuel pump comprising:
a pump body in which a fuel introduction passage for introducing fuel from an outside and a pump operation chamber for introducing the fuel through the fuel introduction passage are formed; and
a pressurizing pump mechanism having an input part lubricated by oil from the outside and operative to pressurize and discharge the fuel in the pump operation chamber by a power inputted to the input part, wherein
the pump body includes a fuel accommodation portion formed with at least part of the fuel introduction passage, and a barrier wall portion for regulating the oil from being introduced into a fuel accommodation portion, and wherein
the fuel accommodation portion and the barrier wall portion are connected with each other through a heat transmission path which is provided therein with a heat transmission member having a higher heat transfer performance than that of a material forming the pump body, the heat transmission member includes a connecting part exposed to the outside of the pump body.

2. The fuel pump as set forth in claim 1, wherein
the pump body is mounted on an outer wall portion of an internal combustion engine, and the input part inputs a power from a driving member mounted on the internal combustion engine, and wherein
the heat transmission member has an end portion projected from the pump body, the end portion being connected to a low temperature portion forming part of the internal combustion engine and lower in temperature than the remaining portion thereof.

3. The fuel pump as set forth in claim 1 or claim 2, wherein the heat transmission member includes a high heat conduction member having a higher heat conductivity than that of the material forming the pump body, and a heat insulating sheath member covering part of the high heat conduction member protruded from the pump body.

4. The fuel pump as set forth in claim 3, wherein the high heat conduction member is formed in a band-like shape or a string-like shape.

5. The fuel pump as set forth in claim 1, wherein the heat transmission member includes a heat pipe.

6. The fuel pump as set forth in claim 1, wherein
the pressurizing pump mechanism is constituted by a pump operative to reciprocate a plunger, and the input part is provided at an outer end portion of the plunger, and wherein
the barrier wall portion of the pump body is arranged, in a direction in which the plunger is reciprocated, between the pump operation chamber of the fuel introduction passage in the pump body and the outer end portion of the plunger of the pressurizing pump mechanism.

7. A fuel supply system of an internal combustion engine, provided with the fuel pump as set forth in claim 1, the fuel supply system comprising
a feed pump operative to pump up fuel from a fuel tank and to feed the fuel to the fuel introduction passage; and
a delivery pipe for storing fuel pressurized and discharged by the pressurizing pump mechanism and supplying the fuel to a fuel injection valve, wherein
the fuel accommodation portion of the pump body has a fuel storing chamber formed therein, the fuel storing chamber forming part of the fuel introduction passage and storing the fuel from the feed pump, and wherein
the heat transmission member is extended to a vicinity of the fuel storing chamber in the fuel accommodation portion.
